(19) United States
(12) Patent Application Publication
(10) Pub. No.: US 2025/0241337 A1
(43) Pub. Date: Jul. 31, 2025

(54) Extruded High Protein and High Fiber Food Pieces and Methods of Making

(71) Applicant: General Mills, Inc., Minneapolis, MN (US)

(72) Inventors: Jose Daniel Estrada Andino, Roseville, MN (US); Obediah Cooper, Coon Rapids, MN (US); Douglas L. Goedeken, Blaine, MN (US); Eric T. Gugger, Plymouth, MN (US); James Lombel, St. Michael, MN (US); Ravindranath Sreedhar Menon, Rogers, MN (US); Scott K. Whitman, New Hope, MN (US); Elizabeth Witt, Prior Lake, MN (US)

(21) Appl. No.: 18/625,835

(22) Filed: Apr. 3, 2024

Related U.S. Application Data
(60) Provisional application No. 63/625,499, filed on Jan. 26, 2024.

(51) Int. Cl. A23J 3/14; A23J 3/16; A23J 3/26; A23L 7/122; A23L 29/30

(52) U.S. Cl. CPC A23J 3/14; A23J 3/16; A23J 3/26; A23L 7/122; A23L 29/35

(57) ABSTRACT

The present disclosure relates to high protein, high fiber ready-to-eat food pieces, compositions including such food pieces, and methods of making such food pieces. The pieces include a plant-based protein ingredient in an amount of about 25% to about 55% by dry weight protein and an insoluble fiber ingredient contributing insoluble fiber in an amount of at least 12% by dry weight of the pieces. Food pieces can optionally contain a soluble carbohydrate ingredient in an amount of about 8% to about 30% by dry weight, where the soluble carbohydrate ingredient includes psyllium and/or a high molecular weight soluble carbohydrate.

### CROSS REFERENCE TO RELATED APPLICATIONS

This application claims the benefit of U.S. Provisional Patent Application Ser. No. 63/625,499, which was filed on Jan. 26, 2024 and titled “Extruded Puffed High Protein and High Fiber Food Pieces and Methods of Making”. The entire content of this application is incorporated by reference.

### TECHNOLOGY

The present disclosure generally relates to an extruded high protein, high fiber product and methods of making such a product.

### BACKGROUND

High protein food products have found popularity among consumers as a way to eat nutritionally dense foods. In addition, high fiber foods can supplement fiber consumption. Consumers want diverse ways to get increased protein and fiber into their diets. Thus, there is a need for new high protein, high fiber food products to satisfy the increasing consumer desire for protein.

### SUMMARY

High protein, high fiber ready-to-eat (RTE) food pieces and methods of making such food pieces are provided herein.

Food pieces and compositions including such food pieces are provided herein. Ready-to-eat (RTE) food pieces and compositions including such food pieces are provided herein. A food piece includes at least 60% by dry weight of the food piece of a combination of a plant-based protein ingredient and an insoluble fiber ingredient, where: the plant-based protein ingredient is included in an amount of about 25% to about 55% by dry weight of the food piece, the protein ingredient comprising pea protein, soybean protein, canola protein, or chickpea protein and contributing about 25% to about 45% protein dry weight of the food piece; the insoluble fiber ingredient is included in an amount of about 15% to about 45% by dry weight of the food piece, the insoluble fiber ingredient contributing insoluble fiber in an amount of at least 12% by dry weight of the food piece; the food pieces have a total fiber content of about 25% to about 40% by dry weight of the food piece; the food piece has a moisture content of up to 5% by weight of the food piece; and the food piece has a bulk density range of from 300 to 750 grams per 100 cubic inches.

In some embodiments, a soluble carbohydrate ingredient can be included in a food piece in an amount of about 8% to about 30% by dry weight of the food piece, the soluble carbohydrate ingredient comprising psyllium or a high molecular weight (HMW) soluble carbohydrate in an amount of at least 75% by dry weight of the soluble carbohydrate ingredient, the HMW soluble carbohydrate having: an average degree of polymerization (DP) at least 20; and/or an average dextrose equivalent (DE) of less than 4. In some embodiments, the ratio of protein ingredient + insoluble fiber ingredient to soluble carbohydrate ingredient can be from about 2:1 to about 8:1.

In some embodiment, the food piece can have a total protein content of about 30% to about 45% by dry weight of the food piece, and the ratio of the total protein content to the total fiber content can be from about 1.5:1 to about 1:1.5.

In some embodiments, the insoluble fiber ingredient in a food piece can include bran.

In some embodiments, a food piece can include a grain flour in an amount of about 1% to about 15% by dry weight of the food piece. In some embodiments, the grain flour can include corn meal.

In some embodiments, the soluble carbohydrate ingredient in a food piece can include psyllium in an amount of up to about 10% by dry weight of the food piece.

In some embodiments, the HMW soluble carbohydrate in a food piece can include maltodextrin in an amount of up to about 25% by dry weight of the food piece.

In some embodiments, a food piece can consist of: a plant-based protein ingredient in an amount sufficient to contribute soybean and/or pea protein in an amount of about 28% to about 48% by dry weight of the food piece; an insoluble fiber ingredient in an amount sufficient to contribute insoluble fiber in an amount of about 15% to about 35% by dry weight of the food piece; soluble carbohydrate ingredient including at least 20% soluble fiber by weight of the ingredient and contributing soluble fiber in an amount of about 5% to about 20% by dry weight of the food piece, where the total fiber content is from about 26% to about 36% by dry weight of the food piece; grain flour in an amount of about 2% to about 10% by dry weight of the food piece, the grain flour including corn meal; and other ingredients in an amount of less than 10% by dry weight of the food piece, where the moisture content is 4% or less by weight of the food piece.

Any food piece described herein can be suitable coated on at least a portion of the food piece. In some embodiments, a coating can be included in an amount of about 10% to about 50% by weight of coated food pieces.

Compositions containing food pieces and/or coated food pieces according to any embodiment along with one or more other edible component (e.g., other food pieces, binders, and the like) are also provided.

Methods of making RTE food pieces are provided. A method of making RTE food pieces can include combining ingredients under extrusion conditions to form a dough having a moisture content of about 8% to about 30% and a total fiber content of about 25% to about 40% by dry weight of the dough, the ingredients having at least 60% by dry weight of the dough of combination of a plant-based protein ingredient and an insoluble fiber ingredient; forming the dough from an extrusion die to form dough pieces; and drying the dough pieces to form a plurality of food pieces having a bulk density of about 300 to about 750 grams per 100 cubic inches and a moisture content of 5% or less by weight to form the plurality of food pieces. The plant-based protein ingredient can be included in an amount of about 25% to about 55% by dry weight of the dough, where the protein ingredient includes pea protein, soybean protein, canola protein, or chickpea protein and contributes about 25% to about 45% protein dry weight of the dough. The insoluble fiber ingredient can be included in an amount of about 15% to about 45% by dry weight of the dough, where the insoluble fiber ingredient contributes insoluble fiber in an amount of at least 12% by dry weight of the dough.

In some embodiments, a dough can include a soluble carbohydrate ingredient in an amount of about 8% to about 30% by dry weight of the food pieces, the soluble carbohydrate ingredient including psyllium or a high molecular weight (HMW) soluble carbohydrate in an amount of at least 75% by dry weight of the soluble carbohydrate ingredient, the HMW soluble carbohydrate having: an average degree of polymerization (DP) at least 20; or an average dextrose equivalent (DE) of less than 4. In some embodiments, the ratio of protein ingredient + insoluble fiber ingredient to soluble carbohydrate ingredient can be from about 2:1 to about 8:1. In some embodiments, the soluble carbohydrate ingredient can include psyllium in an amount of up to about 10% by dry weight of the dough. In some embodiments, the HMW soluble carbohydrate includes maltodextrin in an amount of up to about 25% by dry weight of the dough.

In some embodiments, a dough can have a total protein content of about 30% to about 45% by dry weight of the dough, and the ratio of the total protein content to the total fiber content can be from about 1.5:1 to about 1:1.5.

In some embodiments, the dough can include a grain flour in an amount of about 1% to about 15% by dry weight of the dough.

These and various other features and advantages will be apparent from a reading of the following detailed description.

### DETAILED DESCRIPTION

Consumers continually expect an even greater variety of nutrient dense, convenient foods that are suitable for different eating occasions, including foods that contain high concentrations of protein and fiber. However, protein ingredients, particularly non-animal derived protein ingredients, often suffer from bitter taste, astringency, and/or off-flavor/aroma. Fiber ingredients, especially insoluble fiber ingredients, often contribute to taste, astringency, and textural problems, especially when included at high levels. Thus, while grain-based products are available with supplemental protein content (i.e., protein content beyond that contributed by the grain-based component(s)) and/or supplemental fiber content (i.e., fiber content beyond that contributed by grain-based component(s)), such products often have a harder, crunchier, grittier, and/or glassier texture when attempting to replicate traditional grain-based RTE food products. Such products also tend to suffer from off-flavors and/or bitterness. The present application describes the discovery of high protein, high fiber compositions that can be extruded into RTE food pieces having a pleasant, crunchy texture suitable for eating alone or in RTE compositions, such as snack bars, clusters, or RTE baked goods, and having a pleasant or neutral flavor, even in the absence of flavorants or off-flavor maskers.

A food piece provided herein is a high protein, high fiber, and ready-to-eat (RTE) food piece. As used herein, the term “high protein” refers to a food piece that includes protein in an amount of about 25% to about 45% by dry weight of the piece (e.g., about 30% to about 45%) by dry weight of the food piece. The term “high fiber” refers to a food piece that includes a total fiber content of about 25% to about 40% (e.g., about 26% to about 36%) by dry weight of the food piece. In some embodiments, a food piece described herein can have a total fiber content and a protein content that are similar (e.g., included at a ratio of about 1.5:1 to about 1:1.5, or about 1:1).

A food piece provided herein has a bulk density of about 300 to about 750 (e.g., about 350 to about 720) g/100 cubic inches. A food piece having such a density can advantageously bring high levels of protein and fiber to a RTE food product without excessive bulk. In addition, a food piece having the described density remains surprisingly crunchy without being too hard. Thus, a food piece provided herein remains suitable for eating alone as a RTE food product, yet also can be used in RTE products, such as snack bars without adding excessive bulk.

As used herein, the term “ready-to-eat” (“RTE”) refers to a food that does not require further cooking or preparation to be suitable and safe for consumption. A food piece provided herein is typically also shelf stable at room temperature for at least 6 months (e.g., at least 8 months, or 12 months to 18 months) without significant negative impact on texture, structure, or flavor when stored in appropriate packaging. A food piece provided herein typically has dimensions that are suitable for inclusion in a RTE food, such as a granola bar. A food piece provided herein can also be suitably coated, or it can be used in other products, such as dry snacks, as inclusions to be mixed in other products (e.g., yogurt or pudding), in snack blends, or in cold-formed or baked snack bars or clusters.

A food piece provided herein comprises at least 60% (e.g., at least 65%) by dry weight of a combination of a plant-based protein ingredient and an insoluble fiber ingredient. In some embodiments, a food piece provided herein comprises at least 65% (e.g., at least 70%, or at least 75%) by dry weight of a combination of a plant-based protein ingredient, an insoluble fiber ingredient, and a soluble carbohydrate ingredient comprising psyllium and/or a high molecular weight (HMW) soluble carbohydrate.

A food piece provided herein includes a plant-based protein ingredient in an amount of about 25% to about 55% (e.g., about 28% to about 48%) by dry weight of the food piece. A plant-based protein ingredient can contribute protein in an amount of about 25% to about 45% (e.g., about 30% to about 42%) by dry weight of the food piece. Total protein in a food piece provided herein ranges from about 28% to about 50% (e.g., about 30% to about 45%) by dry weight of the food piece, and includes protein content combined from all of the included ingredients (e.g., protein ingredient, grain flour, and insoluble fiber ingredient).

Generally, a plant-based protein ingredient can have a protein content of at least 60% (e.g., at least 65%, at least 70%, or at least 75%) by dry weight of the protein ingredient. In some embodiments, a plant-based protein ingredient comprises a legume protein (e.g., soybean protein, pea protein, chickpea protein, fava bean protein, lentil protein, and the like). In some embodiments, a plant-based protein ingredient can include protein from a non-legume plant source, such as wheat, rice, corn, canola, and the like. In some embodiments, a plant-based protein ingredient can have a protein content that consists of soybean protein, pea protein, canola protein, chickpea protein, or any combination thereof. A plant-based protein ingredient can comprise, for example, legume flours (e.g., soybean flour or the like), protein concentrates (e.g., soybean protein concentrate, pea protein concentrate, fava bean protein concentrate, canola protein concentrate, chickpea protein concentrate, or the like), protein isolates (e.g., soybean protein isolate, pea protein isolate, chickpea protein isolate, or the like), and the like, or any combination thereof.

In some embodiments, a plant-based protein ingredient has at least a portion (e.g., at least 60%, at least 70%, or at least 90%) of its protein content comprising a protein source that has a protein digestibility-corrected amino acid score (PDCAAS) of at least 60%. Examples of such proteins include, without limitation, soybean protein, which typically has a PDCAAS of about 90% to about 100%, pea protein, which typically has a PDCAAS of at least 60%, chickpea protein, which typically has a PDCAAS of at least 70%, quinoa protein, which typically has a PDCAAS of at least 60%, and rapeseed protein, which typically has a PDCAAS of at least 80%. PDCAAS of a protein is calculated according to the Food and Agriculture Organization of the United Nations (Joint FAO/WHO Expert Consultation (1990), Protein Quality Evaluation. Report of a Joint FAO/WO Expert Consultation held in Bethesda, MD, USA, 4-8 Dec. 1989. Food and Agriculture Organization, Rome. Section 8. ISBN 92-5-103097-9).

A food piece provided herein includes an insoluble fiber ingredient in an amount of about 15% to about 45% by dry weight of the food piece. As used herein, an insoluble fiber ingredient consists of an insoluble fiber source (e.g., bran, cellulose, oat hull fiber, sugar cane fiber, and the like). An insoluble fiber ingredient can contribute insoluble fiber to a food piece described herein in an amount of at least 12% (e.g., about 15% to about 35%) by dry weight of the food piece.

Bran is a particularly suitable source of insoluble fiber. As used herein the term “bran” refers to the combined aleurone and pericarp of a cereal grain (e.g., corn, wheat, rice, barley, rye, oat, and the like). Insoluble fiber content of a bran suitable for use herein can range from about 40% to about 85% by dry weight. In some embodiments, bran in a food piece can have an average insoluble fiber content of greater than 50% by dry weight of the bran. In some embodiments, bran in a food piece can include bran from a combination of sources. For example, in some embodiments, a bran with an insoluble fiber content of 50% or less by weight (e.g., wheat bran, oat bran, rice bran) and a bran with an insoluble fiber content of greater than 50% (e.g., corn bran, rye bran, barley bran), can be combined at a ratio suitable to achieve an average insoluble fiber content of greater than 50%. For example, corn bran and wheat bran can suitably be used at a ratio of about 1:1 to about 1:3 (e.g., about 1:2). Other components of a bran can include, for example, starch, soluble fiber, protein, and fat.

In some embodiments, food piece can include a soluble carbohydrate ingredient in an amount of about 8% to about 30% by dry weight of the food piece. In some cases, soluble carbohydrate ingredient can be include in an amount such that the ratio of the combined amount of protein ingredient and insoluble fiber ingredient to the amount of soluble carbohydrate ingredient in a food piece can be from about 2:1 to about 8:1. As used herein, the term “soluble carbohydrate ingredient” comprises at least 75% (e.g., at least 80%, or at least 90%) by dry weight of psyllium husk, a high molecular weight (HMW) soluble carbohydrate, or a combination thereof. As used herein, a HMW soluble carbohydrate is a carbohydrate (e.g., maltodextrin, polydextrose, inulin, soluble corn fiber, or the like) whose monosaccharide base units comprises at least 90% glucose and/or fructose, and which is soluble in water. A HMW soluble carbohydrate has an average degree of polymerization (DP) of at least 20 (e.g., at least 25, at least 30, at least 50, or at least 55) and/or an average dextrose equivalent (DE) of less than 4 (e.g., less than 3.5, 3.3 or less, 3.0 or less, about 1 to about 3, or about 1 to about 2). A HMW soluble carbohydrate does not include pregelatinized starches, starches with a DP of greater than 100, or gums (e.g., xanthan gum, guar gum, or the like).

In some embodiments, a soluble carbohydrate ingredient can contribute psyllium to a food piece in an amount of up to about 10% (e.g., up to about 9%, or about 1% to about 8%) by dry weight of the food piece. Although optional, psyllium can contribute to a desired texture of a food piece that is less hard and/or gritty than a food piece that contains no soluble carbohydrate ingredient or contains only HMW soluble carbohydrate in a soluble carbohydrate ingredient, while also contributing soluble fiber.

In some embodiments, a soluble carbohydrate ingredient can contribute HMW soluble carbohydrate (e.g., maltodextrin, inulin, soluble corn fiber) in an amount of up to about 25% (e.g., up to about 22%, or up to about 20%) by dry weight of a food piece. In some embodiments, a HMW soluble carbohydrate can contribute to a harder and/or denser texture than a food piece that contains no soluble carbohydrate ingredient or contains only psyllium in a soluble carbohydrate ingredient. In some cases, a HMW soluble carbohydrate can surprisingly reduce plant protein off-flavor in a food piece. In addition, a HMW soluble carbohydrate can contribute to increased surface smoothness and/or roundness of food pieces. In some embodiment, a HMW soluble carbohydrate can comprise a HMW soluble fiber.

In some embodiments, a food piece provided herein can include a grain flour in an amount of up to about 15% (e.g., about 1% to about 15%, or about 2% to about 10%) by dry weight of the food piece. As used herein, a grain flour refers to a food ingredient obtained by grinding a grain (e.g., wheat, corn, rice, oat, barley, and the like). In some embodiments, a grain flour alternative can be substituted in-part or fully for a grain flour. Examples of grain flour alternatives can include seed and/or pseudo grain flour (e.g., sunflower, millet, buckwheat, sorghum), tuber flour (e.g., tapioca flour, potato flour, or the like), or the like, or combinations thereof. A grain flour is not limited to finely ground flours, and can include coarse flours such as corn meal and/or corn cones. If included, coarseness of a grain flour can modify density of a food piece, with more coarse grain flours generally leading to a more dense food piece.

A grain flour referred to herein can be a whole grain flour or a refined flour, however, a grain flour referred to herein does not refer to isolated and/or extracted starches. In some embodiments, at least a portion of a grain flour (e.g., at least 20%, at least 50%, or at least 80% by weight of the grain flour) included in a food piece can comprise a whole grain flour.

Density can be adjusted by adjusting the ratios of plant-based protein ingredient, insoluble fiber ingredient, and optional HWM carbohydrate ingredient relative to each other. Generally, density of food pieces also generally increased as protein ingredient content increased.

Additional other ingredients can optionally be included in a combined amount of up to 30% (e.g., up to 15%, less than 10%, or up to 7%) by dry weight of a food piece. For example, a sweetener (e.g., sugar, sugar alcohol, high potency sweetener, or the like) can be included to contribute to flavor/sweetness and/or structure or texture; colorants and/or flavorants (e.g., salt, vanilla, cocoa, cinnamon, natural and/or artificial coloring, or the like) to provide a desired appearance or flavor; oil (e.g., canola oil, corn oil, olive oil, soy oil, sunflower oil, and the like, or any combination thereof) to provide texture and flavor benefits; animal-derived protein ingredients (e.g., casein or caseinate, whey protein, milk powder, egg, and the like) to provide flavor, texture, and/or nutritional benefits; and/or minors, such as vitamins, minerals, calcium carbonate, processing aids, and the like.

Food pieces provided herein typically have a moisture content of 5% or less (e.g., about 1% to about 4%, or about 2% to about 3.5%) by weight.

In some embodiments, a food piece provided herein can have a coating on at least a portion of a surface of the food piece. For example, a sugar-based, sugar alcohol-based, fruit-and/or vegetable-based, or fat-based coating can be applied on at least a surface of a food piece to modify the taste, texture, bowl life (e.g., in a bowl of milk), nutritional profile, and/or appearance of the food piece. In another example, a food piece can be sprayed with oil and a dry seasoning (e.g., cinnamon, sugar, chili, oregano, cocoa powder, or the like, or any combination thereof) can be dusted onto the surface.

Also provided herein are compositions comprising a plurality of food pieces provided herein. In some embodiments, a composition can contain edible components other than the food pieces provided herein. For example, a composition can comprise dried fruit, nuts, confectionery pieces, grain-based pieces, protein-based pieces, or the like. In some embodiments, a composition can comprise coated food pieces provided herein. A composition comprising coated food pieces can contain pieces that are partially or entirely coated and, in some cases, uncoated pieces as well as coated pieces.

Methods of making food pieces are also provided. Generally, food pieces are produced by combining ingredients under extrusion conditions to form a dough. As used herein, the term “extrusion conditions” refers to subjecting a composition to heat, pressure, and shear in an extruder (e.g., single screw extruder, twin screw extruder, triple screw extruder, ring extruder, or the like). For example, a co-rotating, intermeshing, twin screw extruder can be used in a method provided herein. Manufacturers for co-rotating twin screw extruders include, for example, Coperion, Wenger, Clextral, Berstorff, APV, Baker Perkins, Buhler, and Leistritz.

In some embodiments, food pieces provided herein can be extruded in a twin screw extruder with a barrel temperature of at least 180° F. (e.g., about 220° F. to about 350° F.). As used herein, the term “barrel temperature” refers to the maximum temperature of a heated barrel of an extruder. In some embodiments, extrusion conditions can comprise a specific mechanical energy (SME) of about 60 to about 120 Wh/kg. In some embodiments, extrusion conditions can comprise a die pressure of about 450 to about 2200 (e.g., about 500 to about 1500) psi.

A dough is typically made in a continuous fashion by feeding ingredients into an extruder during an extrusion process. In some embodiments, dry ingredients can be combined to produce a dry mix prior to being combined with water or other aqueous ingredients and, optionally, oil to produce a composition suitable for extrusion. In some embodiments, dry ingredients and a portion of water can be combined in a preconditioner prior to being fed into an extruder.

The dough generally contains the ingredients described above with regard to the food pieces. That is, the dough comprises at least 60% by dry weight of a combination of a plant-based protein ingredient and an insoluble fiber ingredient, and, optionally a soluble carbohydrate ingredient in an amount of about 8% to about 30% by dry weight of the dough. A plant-based protein ingredient is typically included in a dough in an amount of about 25% to about 55% by dry weight of the dough. An insoluble fiber ingredient is typically included in a dough in an amount sufficient to contribute insoluble fiber in an amount of at least 12% by dry weight of the dough. A dough can optionally include other ingredient in a combined amount of up to 30% (preferably, less than 10%) by dry weight of the dough.

A dough produced in a method provided herein typically includes a moisture content of from about 8% to about 40% (e.g., about 15% to about 30%) by weight of the dough.

The dough can then be extruded from an extrusion die to form dough pieces. The dough pieces can be dried to a final moisture of less than 5% and density of 300 to 750 g per 100 cubic inches. Drying can be performed using any suitable method and equipment, such as a belt dryer.

In some embodiments, food pieces provided herein can have average diameter of from about 0.5 mm to about 20 mm (e.g., from about 1 mm to about 10 mm, or about 1.5 mm to about 5 mm). However, the size of a food piece can be adjusted for the desired use of the food piece or to provide a manufacturing advantage. For example, the size of a food piece can be adjusted to provide a desired size for eating as a stand-alone RTE breakfast cereal or snack, or for use as a component in a snack bar or snack mix. In another example, the size of a food piece can be adjusted to result in a desired drying time during manufacturing. Piece size can be adjusted using known methods, such as die opening size and/or die opening shape selection, rate of extrusion, and/or cutter speed. For example, cutter speed can be reduced to form elongated puffed pieces, such as pieces resembling churros or snack straws or sticks.

In some embodiments, food pieces provided herein can be packaged and sold as a food product without any other components. Such packaged food pieces can be intended to be eaten as a food product alone or in combination with other food products. For example, food pieces can be packaged and sold as a stand-alone snack, or as part of a RTE breakfast cereal. In some embodiments, a food piece can be adhered with one or more edible components, such as another food piece, nut pieces, fresh or dried fruit pieces, seeds, coconut, grain, and the like, to form a cluster or bar. A food piece and one or more edible components can be adhered to each other using any appropriate method and ingredients (e.g., edible binders and the like). For example, a cluster can be produced using a combination of a food piece and rolled oats adhered using a honey-based binder or slurry. Clusters can be provided as a food product alone or as part of a food product, such as a snack mix, ready to eat cereal, or oatmeal mix.

It is to be understood that food pieces provided herein can be used for either sweet or savory applications in food. Food pieces disclosed herein can provide a benefit of being a high protein, high fiber stand-alone food product or provide added protein and fiber in combination with other components in food products while also providing an improved texture and flavor over other known high protein, high fiber pieces.

### EXAMPLES

Samples were produced by extrusion using a twin screw extruder using the formulations in Table 1. Briefly, dry ingredients were blended to make a dry mix and then combined with water to arrive at a dough moisture indicated in Table 1. The dough was extruded from a die opening and cut into pieces approximately 2 mm to 10 mm. The dough pieces were dried to a moisture of about 4% using tray dryer or a belt dryer.

TABLE 1

| | Pea | Soy | | HMW | | Corn | |
|---|---|---|---|---|---|---|---|
| | protein | protein | Bran | carbo- | | meal | |
| | isolate | isolate | (% | hydrate | Psyllium | (% | |
| | (% dry | (% dry | dry | (% dry | (% dry | dry | Dough |
| Sample | mix) | mix) | mix) | mix) | mix) | mix) | moisture |
| 1 | 0% | 36-40% | 30-34% | 6-10% | 8-12% | 8-12% | 20-22% |
| 2 | 0% | 42-48% | 30-34% | 0% | 8-12% | 8-12% | 20-22% |
| 3 | 0% | 42-48% | 40-44% | 0% | 0% | 8-12% | 22-24% |
| 4 | 0% | 42-48% | 18-22% | 18-22% | 0% | 8-12% | 15-17% |
| 5 | 40-44% | 0% | 24-28% | 16-20% | 6-10% | 1-4% | 14-16% |
| 6 | 46-50% | 0% | 24-28% | 6-10% | 6-10% | 2-6% | 16-18% |
| 7 | 46-50% | 0% | 32-36% | 6-10% | 0% | 2-6% | 18-20% |
| 8 | 46-50% | 0% | 16-20% | 24-28% | 0% | 2-6% | 15-17% |

Table 2 shows the bulk density measured for each sample, the total fiber and total protein content, and the total protein to total fiber ratio for each sample.

TABLE 2

| | Bulk density | Total | | |
|---|---|---|---|---|
| | (grams per 100 | protein (% | Total fiber (% | Protein:Fiber |
| Sample | inch³) | dry wt) | dry wt) | ratio |
| 1 | 540-560 | 34-35% | 34-35% | 1:1 |
| 2 | 460-480 | 40-42% | 34-35% | 1.2:1 |
| 3 | 580-600 | 40-42% | 34-35% | 1.2:1 |
| 4 | 700-720 | 40-42% | 34-35% | 1.2:1 |
| 5 | 480-500 | 34-35% | 27-29% | 1.2:1 |
| 6 | 550-570 | 40-42% | 27-29% | 1.4:1 |
| 7 | 680-700 | 40-42% | 27-29% | 1.4:1 |
| 8 | 700-720 | 40-42% | 27-29% | 1.4:1 |

The samples each had an acceptable texture and flavor without requiring any flavorants, sugar, or flavor maskers, with samples 2, 4, 6, and 8 being most preferred and samples 3 and 7 being least preferred. Samples with a protein to fiber ratio of greater than 1.2:1 appeared to benefit from inclusion of a soluble carbohydrate ingredient (HMW soluble carbohydrate and/or psyllium) in an amount of at least 12% by dry weight of the dry mix. Samples that included a soluble carbohydrate ingredient tended to be less astringent and were perceived to be softer than those that didn't include a soluble carbohydrate ingredient. However, samples that did not include a soluble carbohydrate ingredient remained acceptable. Samples that included psyllium tended to have reduced grittiness, and increased radial expansion during extrusion. Some samples that included HMW soluble carbohydrate were perceived to have reduced plant protein flavor, and tended to have a higher density, smoother surface, and more round shape.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A composition comprising a plurality of ready-to-eat (RTE) food pieces, the food pieces comprising at least 60% by dry weight of the food pieces of a combination of a plant-based protein ingredient and an insoluble fiber ingredient, wherein:
a. the plant-based protein ingredient is included in an amount of about 25% to about 55% by dry weight of the food pieces, the protein ingredient comprising pea protein, soybean protein, canola protein, or chickpea protein and contributing about 25% to about 45% protein dry weight of the food pieces;
b. the insoluble fiber ingredient is included in an amount of about 15% to about 45% by dry weight of the food pieces, the insoluble fiber ingredient contributing insoluble fiber in an amount of at least 12% by dry weight of the food pieces;
c. the food pieces have a total fiber content of about 25% to about 40% by dry weight of the food pieces;
d. the food pieces have a moisture content of up to 5% by weight of the food pieces; and
e. the food pieces have a bulk density range of from 300 to 750 grams per 100 cubic inches.

2. The composition of claim 1, comprising a soluble carbohydrate ingredient in an amount of about 8% to about 30% by dry weight of the food pieces, the soluble carbohydrate ingredient comprising psyllium or a high molecular weight (HMW) soluble carbohydrate in an amount of at least 75% by dry weight of the soluble carbohydrate ingredient, the HMW soluble carbohydrate having:
a. an average degree of polymerization (DP) at least 20; or b. an average dextrose equivalent (DE) of less than 4.

3. The composition of claim 2, wherein the ratio of protein ingredient +insoluble fiber ingredient to soluble carbohydrate ingredient is from about 2:1 to about 8:1.

4. The composition of claim 1, wherein the food pieces have a total protein content of about 30% to about 45% by dry weight of the food pieces, and the ratio of the total protein content to the total fiber content is from about 1.5:1 to about 1:1.5.

5. The composition of claim 1, wherein the insoluble fiber ingredient comprises bran.

6. The composition of claim 1, wherein the food pieces comprise a grain flour in an amount of about 1% to about 15% by dry weight of the food pieces.

7. The composition of claim 6, wherein the grain flour comprises corn meal.

8. The composition of claim 1, wherein the soluble carbohydrate ingredient comprises psyllium in an amount of up to about 10% by dry weight of the food pieces.

9. The composition of claim 1, wherein the HMW soluble carbohydrate comprises maltodextrin in an amount of up to about 25% by dry weight of the food pieces.

10. The composition of claim 1, wherein the food pieces consist of:
a. the plant-based protein ingredient in an amount sufficient to contribute soybean and/or pea protein in an amount of about 28% to about 48% by dry weight of the food pieces;
b. the insoluble fiber ingredient in an amount sufficient to contribute insoluble fiber in an amount of about 15% to about 35% by dry weight of the food pieces;
c. soluble carbohydrate ingredient comprising at least 20% soluble fiber by weight of the ingredient and contributing soluble fiber in an amount of about 5% to about 20% by dry weight of the food pieces, wherein the total fiber content is from about 26% to about 36% by dry weight of the food pieces;
d. grain flour in an amount of about 2% to about 10% by dry weight of the food pieces, the grain flour comprising corn meal; and
e. other ingredients in an amount of less than 10% by dry weight of the food pieces,
wherein the moisture content is 4% or less by weight of the food pieces.

11. A composition, comprising a plurality of coated food pieces, the coated food pieces comprising:
a. the plurality of food pieces according to claim 1; and
b. a coating on at least a portion of a surface of at least a portion of the food pieces.

12. The composition of claim 11, wherein the coating comprises about 10% to about 50% by weight of the coated food pieces.

13. The composition, comprising a plurality of food pieces or coated food pieces according to claim 1, and edible components other than the food pieces or coated food pieces.

14. A method of making a plurality of RTE food pieces, comprising:
a. combining ingredients under extrusion conditions to form a dough having a moisture content of about 8% to about 30% and a total fiber content of about 25% to about 40% by dry weight of the dough, the ingredients comprising at least 60% by dry weight of the dough of combination of a plant-based protein ingredient and an insoluble fiber ingredient, wherein:
i. the plant-based protein ingredient is included in an amount of about 25% to about 55% by dry weight of the dough, the protein ingredient comprising pea protein, soybean protein, canola protein, or chickpea protein and contributing about 25% to about 45% protein dry weight of the dough; and
ii. the insoluble fiber ingredient is included in an amount of about 15% to about 45% by dry weight of the dough, the insoluble fiber ingredient contributing insoluble fiber in an amount of at least 12% by dry weight of the dough;
b. forming the dough from an extrusion die to form dough pieces; and
c. drying the dough pieces to form a plurality of food pieces having a bulk density of about 300 to about 750 grams per 100 cubic inches and a moisture content of 5% or less by weight to form the plurality of food pieces.

15. The method of claim 14, wherein the dough comprises a soluble carbohydrate ingredient in an amount of about 8% to about 30% by dry weight of the food pieces, the soluble carbohydrate ingredient comprising psyllium or a high molecular weight (HMW) soluble carbohydrate in an amount of at least 75% by dry weight of the soluble carbohydrate ingredient, the HMW soluble carbohydrate having:
a. an average degree of polymerization (DP) at least 20; or b. an average dextrose equivalent (DE) of less than 4.

16. The method of claim 15, wherein the ratio of protein ingredient +insoluble fiber ingredient to soluble carbohydrate ingredient is from about 2:1 to about 8:1.

17. The method of claim 14, wherein the dough has a total protein content of about 30% to about 45% by dry weight of the dough, and the ratio of the total protein content to the total fiber content is from about 1.5:1 to about 1:1.5.

18. The method of claim 14, wherein the dough comprises a grain flour in an amount of about 1% to about 15% by dry weight of the dough.

19. The method of claim 14, wherein the soluble carbohydrate ingredient comprises psyllium in an amount of up to about 10% by dry weight of the dough.

20. The method of claim 14, wherein the HMW soluble carbohydrate comprises maltodextrin in an amount of up to about 25% by dry weight of the dough.
